(19) United States
(12) Patent Application Publication
(10) Pub. No.: US 2015/0223129 A1
(43) Pub. Date: Aug. 6, 2015

(54) METHOD FOR CORRECTLY ESTABLISHING A LOCAL IP ACCESS SERVICE

(71) Applicant: Samsung Electronics Co., Ltd., Suwon-si, Gyeonggi-do (KR)

(72) Inventors: Huarui Liang, Beijing (CN); Lixiang Xu, Beijing (CN); Hong Wang, Beijing (CN)

(21) Appl. No.: 14/424,245

(22) PCT Filed: Sep. 16, 2013
(86) PCT No.: PCT/KR2013/008349

§ 371 Date: Feb. 26, 2015

(30) Foreign Application Priority Data
Sep. 21, 2012 (CN) 201210356810.1

(51) Int. Cl. H04W 36/14; H04W 36/00; H04W 36/16

(52) U.S. Cl. CPC H04W 36/14; H04W 36/165; H04W 36/0083

(57) ABSTRACT

The present invention provides a method for correctly establishing a local IP access (LIPA or SIPTO@LN) service. The method includes: obtains a subscribed service type and a device capabilities type of a UE, judging whether the subscribed service type is consistent with the device capabilities type, and establishing a LIPA or SIPTO@LN service for the UE in response to a determination that the subscribed service type is consistent with the device capabilities type, or rejecting establishing the service in response to a determination that the subscribed service type is consistent with the device capabilities type. The present invention guarantees a LIPA or SIPTO@LN service be established correctly, thereby can better satisfy service requirements of users and implement optimal network resources allocation.

### TECHNICAL FIELD

The present invention relates to wireless communications, and particularly to a method for correctly establishing a local IP access (LIPA) service.

### BACKGROUND ART

FIG. 1 is a schematic diagram illustrating a structure of a system architecture evolution (SAE) system. As shown in FIG. 1, user equipment (UE) 101 is a terminal device for receiving data. Evolved universal terrestrial radio access network (E-UTRAN) 102 is a wireless access network which includes eNodeB/NodeB for providing UEs with interfaces for accessing the wireless network. Mobility management entity (MME) 103 is for managing mobility context, session context and security information of UEs. Service gateway (SGW) 104 is mainly for providing user plain functions. MME 103 and SGW 104 may reside in the same physical entity. Packet data network (PDN) gateway (PGW) is for implementing functions including accounting, lawful interception and so on, and may reside in the same physical entity with SGW 104. Policy and charging rule functions (PCRF) 106 provides Quality of Service (QoS) policies and charging rules. Serving GPRS support node (SGSN) 108 is a network node device providing routing for data transmission in the Universal Mobile Telecommunications System (UMTS). Home Subscriber Server (HSS) 109 is a home sub system of UEs, is for maintaining user information including current location, the address of the serving node, user security information, packet data context of a UE, and so on.

3GPP suggests networks should have LIPA capabilities. LIPA refers to a UE accessing a home network or an enterprise network via a Home evolved NodeB (HeNB)/Home NodeB (HNB). In implementing LIPA, a user plain node which is closer to the HeNB/HNB or which is in the HeNB/HNB access network may be selected or re-selected for the UE. The user-plane node may be a core network device or a gateway, such as an SGW or a PGW or a local gateway (LGW) in an SAE system, or a serving GPRS support node (SGSN) or a gateway GPRS support node (GGSN) in a UMTS system.

Currently, LIPA of 3GPP Release 10 (referred to as R10 in the following) does not support mobility, i.e., when a UE moves out of a HeNB/HNB supporting LIPA, LIPA related services of the UE will all be interrupted. In R10, the HeNB/HNB is designed to locate in the same physical entity.

LIPA of 3GPP Release 11 (referred to as R11 in the following) supports mobility, i.e., when a UE moves out of a conventional HeNB/HNB supporting LIPA, LIPA services of the UE will not be interrupted as long as the UE still stays in the home network or the enterprise network. R11 defines standalone LGW and HeNB/HNB, i.e., HeNB/HNB and LGW are designed to locate in different physical entities, and open interfaces between the two entities are also defined.

At present, LIPA services of R11 and LIPA services of R10 are different in that LIPA services of R11 support mobility while LIPA services of R10 does not support mobility and that LIPA services of R11 support multiple PDN connections and request for multiple bearers while LIPA services of R10 only support single PDN connection and request for single bearer.

R12 now provides two services. One of the two services is referred to as LIPA, which indicates only CSG users are currently allowed to access the services provided by local networks and the networks support service continuity of UEs when the UEs moves among the local networks. The other of the two services is referred to as SIPTO@LN, which indicates both CSG users and non-CSG users are currently allowed to access services provided by local networks and the networks support service continuity of UEs when the UEs moves among the local networks. FIG. 2 is a schematic diagram illustrating a structure of a local network supporting LIPA or SIPTO.

But in current 3GPP discussions, there is still no solution to the problem of how to enable the network side to make correct access control decisions to have LIPA or SIPTO@LN services accessed by UEs correctly.

FIG. 3 is a schematic diagram illustrating a structure of a network providing R11 LIPA. As shown in FIG. 3, the interface between HeNB and LGW is SL interface which currently has two possibilities regarding the protocol stacks supported. One of the possibilities is that the SL interface may support both the GTP-C protocol and the GTP-U protocol, and the other is that the SL interface may only support GTP-U protocol. The present invention provides solutions for both of the 2 possibilities respectively.

### DISCLOSURE OF INVENTION

### Technical Problem

The present invention provides a method for correctly establishing a LIPA service, so as to better satisfy service requests of the users and to optimize network resource allocation.

The technical scheme of the present invention is described as follows.

### Solution to Problem

A method for correctly establishing a LIPA service may include:

obtaining subscribed service type of a UE and device capabilities type of a base station, judging whether the subscribed service type of the UE and the device capabilities type of the base station are consistent, establishing the LIPA service or the SIPTO@LN service in response to a determination that the subscribed service type of the UE and the device capabilities type of the base station are consistent; or rejecting the LIPA service or SIPTO@LN service in response to a determination that the subscribed service type of the UE and the device capabilities type of the base station are inconsistent.

The manner of obtaining the subscribed service type of the UE may include: an MME receiving subscription information of the UE, obtaining the subscribed service type of the UE from the subscription information.

The manner of obtaining the device capabilities type of the base station may include: an MME receiving information of device capabilities type of the base station, and obtaining device capabilities type of the base station from the information.

During a handover process of a UE, an MME or a base station may make an access control decision based on a type of a service currently activated for the UE and device capabilities type of the base station, resume the handover process in response to a determination that the type of the activated service of the UE is consistent with the device capabilities of the base station, or reject the handover process or de-activate the LIPA service or the SIPTO@LN service being handed over in response to a determination that the type of the activated service of the UE is inconsistent with the device capabilities of the base station.

### Advantageous Effects of Invention

From the above technical schemes it can be seen that, the method has an extra judging procedure before deciding whether the LIPA service or the SIPTO@LN service is established successfully, i.e., judging whether the LIPA service or the SIPTO@LN service is allowed to be successfully established based on capabilities of an access device and subscription information of the UE, therefore enhances the service experience of the users and optimizes network resources usage.

### BRIEF DESCRIPTION OF DRAWINGS

FIG. 1 is a schematic diagram illustrating a structure of a SAE system according to the prior art.

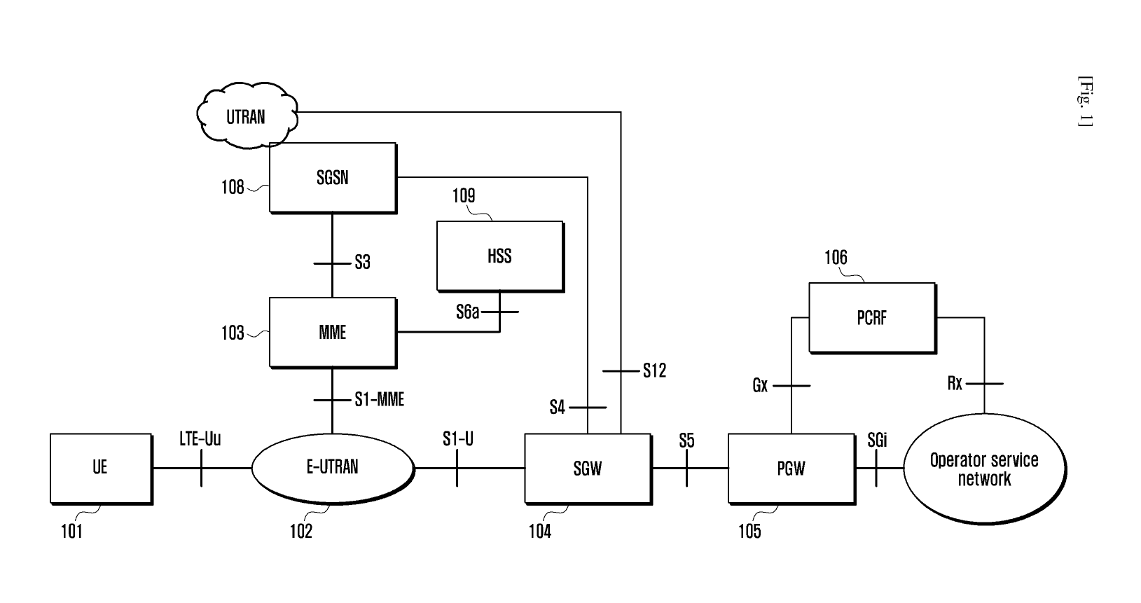

FIG. 2 is a schematic diagram illustrating a structure of a local network supporting LIPA or SIPTO@LN.

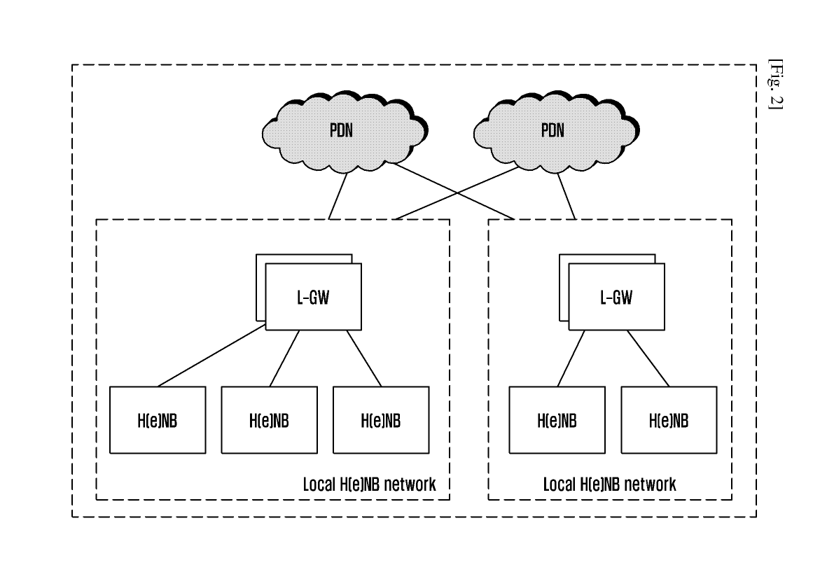

FIG. 3 is a schematic diagram illustrating a structure of a conventional R11 LIPA network.

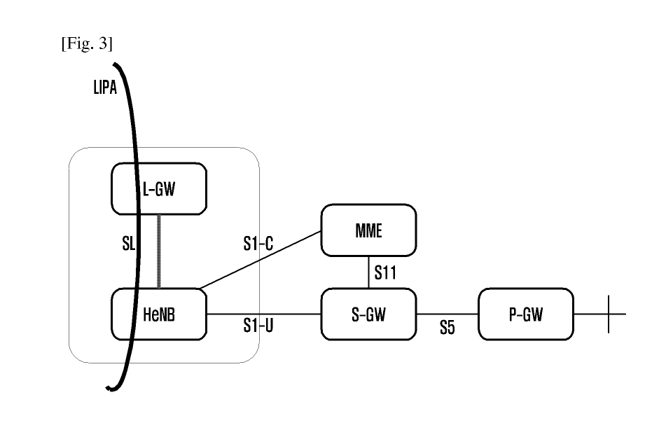

FIG. 4 is a flowchart illustrating a method in accordance with embodiment one of the present invention.

FIG. 5 is a flowchart illustrating a method in accordance with embodiment two of the present invention.

FIG. 6 is a flowchart illustrating a method in accordance with embodiment five of the present invention.

FIG. 7 is a flowchart illustrating a method in accordance with embodiment six of the present invention.

FIG. 8 is a flowchart illustrating a method in accordance with embodiment seven of the present invention.

FIG. 9 is a flowchart illustrating a method in accordance with embodiment eight of the present invention.

FIG. 10 is a flowchart illustrating a method in accordance with embodiment nine of the present invention.

FIG. 11 is a flowchart illustrating a method in accordance with embodiment ten of the present invention.

### MODE FOR THE INVENTION

In order to make the object, solution and merits of the present invention clearer, a detailed description of the present invention is hereinafter given with reference to specific embodiments and the accompanying drawings.

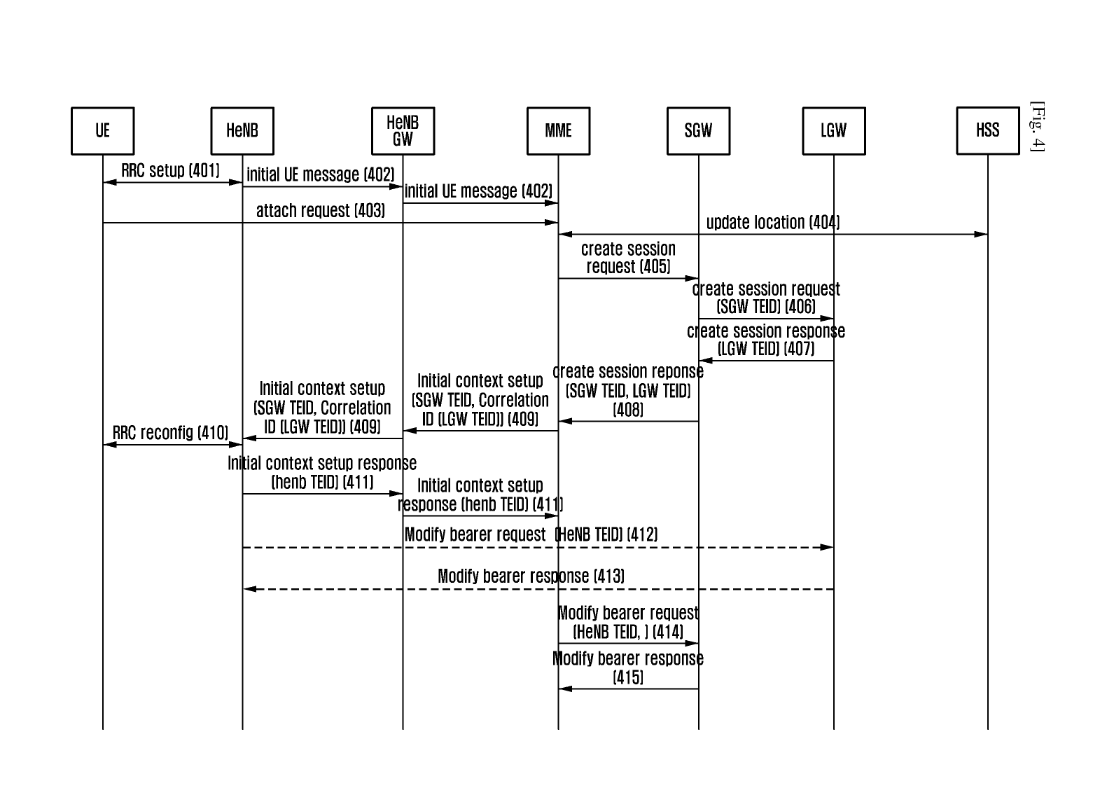

Embodiments of the present invention provide a method for correctly establishing a LIPA service. FIG. 4a is a flowchart illustrating a method for correctly establishing a LIPA service in accordance with an embodiment of the present invention. The method may include the following procedures.

In block 4a01, a subscribed service type of a UE and a device capability type of a base station are obtained.

In block 4a02, it is judged whether the subscribed service type of the UE and the device capability type of the base station are consistent, i.e. the service requested by the UE is supported by the device capabilities type of the base station and is allowed by the subscription data of the UE, and a LIPA service is established for the UE in response to a determination that the two types are consistent, or it is determined whether to establish a LIPA service for the UE based on a pre-stored policy in response to a determination that the two types are inconsistent.

A few embodiments are described below.

### Embodiment One

FIG. 4 is a flowchart illustrating a method in accordance with embodiment one of the present invention. As shown in FIG. 4, the method may include the following procedures.

In block 401, a radio resource control (RRC) establishing process is performed.

In block 402, a HeNB sends an initial UE message to a HeNB GW, and the HeNB GW forwards the initial UE message to a mobility management entity (MME). This embodiment takes a network having HeNB GW deployed as an example. When there is no HeNB GW deployed, the HeNB may send the initial UE message directly to the MME.

The message may include device capabilities of the HeNB. The MME may obtain information of whether the LGW accessed by the HeNB supports LIPA services or SIPTO@LN services or both services by using the device capabilities of the HeNB. (a) The device capabilities may be an individual identification indicating whether the current base station supports LIPA services or SIPTO@LN services or both services. (b) Alternatively, the device capabilities may be expressed by other identifications, e.g., the IP address of the LGW accessed by the current base station. The IP address of the LGW may be used by the MME for selecting a proper LGW for a UE after the MME decides to activate a LIPA service or a SIPTO@LN service for the UE, and may also be used by the MME for determining whether the LGW accessed by the base station supports LIPA services or SIPTO@LN services. For example, different IP addresses may be pre-configured for indicating a current network policy is supporting LIPA services or SIPTO@LN services or both services. (c) Alternatively, the device capabilities may be expressed by using the IP address of the LGW and an ID of a local network name (LHN). The MME may decide whether the base station connected to the MME supports LIPA services or SIPTO services or both services by using the LGW IP address and the LHN ID.

The message may include information of the IP address of the LGW for the MME to select a proper LGW for the UE after the MME decides to activate the LIPA service or SIPTO@LN service. The device capabilities are optional.

The message may include information of the LHN ID for the MME to select a proper LGW for the UE after the MME decides to activate the LIPA service or SIPTO@LN service. The MME may adopt a DNS query manner where the MME may send the LHN ID to a DNS server according to the LHN ID received, and the DNS server may return an IP address which is allowed to access the LGW.

In block 403, the UE sends an attach request to the MME. The message may include information of a service the UE requests to access, e.g., information of an APN supporting the LIPA service or the SIPTO@LN service requested to be accessed.

In block 404, subscription information between the MME and an HSS is updated (update location). The MME may obtain current subscription information of the UE through the message. The subscription information may assist the MME in making an access control decision regarding whether to activate the LIPA service or the SIPTO@LN service for the UE.

The MME may make the access control decision as follows.

In response to a determination that the UE requests to access an APN supporting LIPA, the MME judges whether the UE is allowed to access the LIPA service based on the device capabilities obtained from the HeNB and the subscription information. In response to a determination that the device capabilities sent by the HeNB indicates the LIPA service is supported, e.g., the LGW accessed by the base station supports the LIPA service, the subscription information indicates the UE is a CSG user, and the LIPA ID corresponding to the APN is LIPA-ONLY or LIPA-conditional, the MME allows the UE to access the LIPA service. When any of the above three conditions is not met, the MME rejects the request of the UE for accessing the LIPA service.

In response to a determination that the UE requests to access an APN supporting LIPA, the MME judges whether the UE is allowed to access the LIPA service based on the device capabilities obtained from the HeNB and the subscription information. In response to a determination that the device capabilities sent by the HeNB indicates the LIPA service and the SIPTO@LN service are both supported, the subscription information indicates the UE is a CSG user, and the LIPA ID corresponding to the APN is LIPA-ONLY or LIPA-conditional, the MME allows the UE to access the LIPA service. When any of the above three conditions is not met, the MME rejects the request of the UE for accessing the LIPA service.

In response to a determination that the UE requests to access an APN supporting LIPA, the MME judges whether the UE is allowed to access the LIPA service based on the device capabilities obtained from the HeNB and the subscription information. In response to a determination that the device capabilities sent by the HeNB indicates the SIPTO@LN service is supported, e.g., the LGW currently accessed by the base station supports the SIPTO@LN service, the MME rejects the request of the UE for accessing the LIPA service.

In response to a determination that the UE requests to access an APN supporting SIPTO, the MME judges whether to activate the SIPTO@LN service for the UE based on the received device capabilities of the base station and subscription information. In response to a determination that the information provided by the base station indicates the base station supports SIPTO@LN service or the device capabilities of the base station indicate the base station supports both the LIPA service and the SIPTO@LN service, e.g., the device capabilities provided by the base station indicates the LGW accessed by the base station supports the SIPTO@LN service or both services, and the subscription information supported by the UE indicates the UE is allowed to access the SIPTO@LN service, e.g., a flag indicating SIPTO@LN in the subscription information of the UE has a value indicating SIPTO Allowed including SIPTO@LN or indicating SIPTO@LN Allowed only, the MME may activate the requested SIPTO@LN service for the UE. When any one of the above two conditions is not met, the MME may reject the request to activate the SIPTO@LN service for the UE.

In response to a determination that the UE requests to access an APN supporting SIPTO, the MME judges whether to activate the SIPTO@LN service for the UE based on the received device capabilities of the base station and subscription information. In response to a determination that the information provided by the base station indicates the base station supports the LIPA service, e.g., the device capabilities provided by the base station indicate the LGW accessed by the base station supports the LIPA service, the MME rejects activating the requested SIPTO@LN service for the UE.

In block 405, in response to a determination that the LIPA service or the SIPTO@LN service is allowed to be established for the UE, the MME may send a create session request to an SGW.

In block 406, the SGW may send a create session request to the LGW.

In block 407, the LGW may return a create session response to the SGW.

In block 408, the SGW may send a create session response to the MME.

In block 409, the MME may send to the HeNB GW an initial context setup message which may include a TEID and an IP address of the SGW and a TEID and an IP address of the LGW. The HeNB GW may send to the HeNB an initial context setup message which may include a TEID and an IP address of the SGW and a TEID and an IP address of the LGW.

In block 410, an RRC re-configuration (RRC reconfig) procedure is performed.

In block 411, if the HeNB is an R10 HeNB, the HeNB may send a TEID of the HeNB to the LGW via an internal interface, and send an initial context setup response to the MME.

If the HeNB is an R11 HeNB, the HeNB may send an initial context setup response to the HeNB GW which forwards the response to the MME.

In block 412, the R11 HeNB may send to the LGW a modify bearer request which may include a TEID and an address of the HeNB and a bearer ID.

In block 413, the LGW may send to the R11 HeNB a modify bearer response which may include a bearer ID.

In block 414, the MME may send a modify bearer response to the SGW.

In block 415, the SGW may send a modify bearer response to the MME.

### Embodiment Two

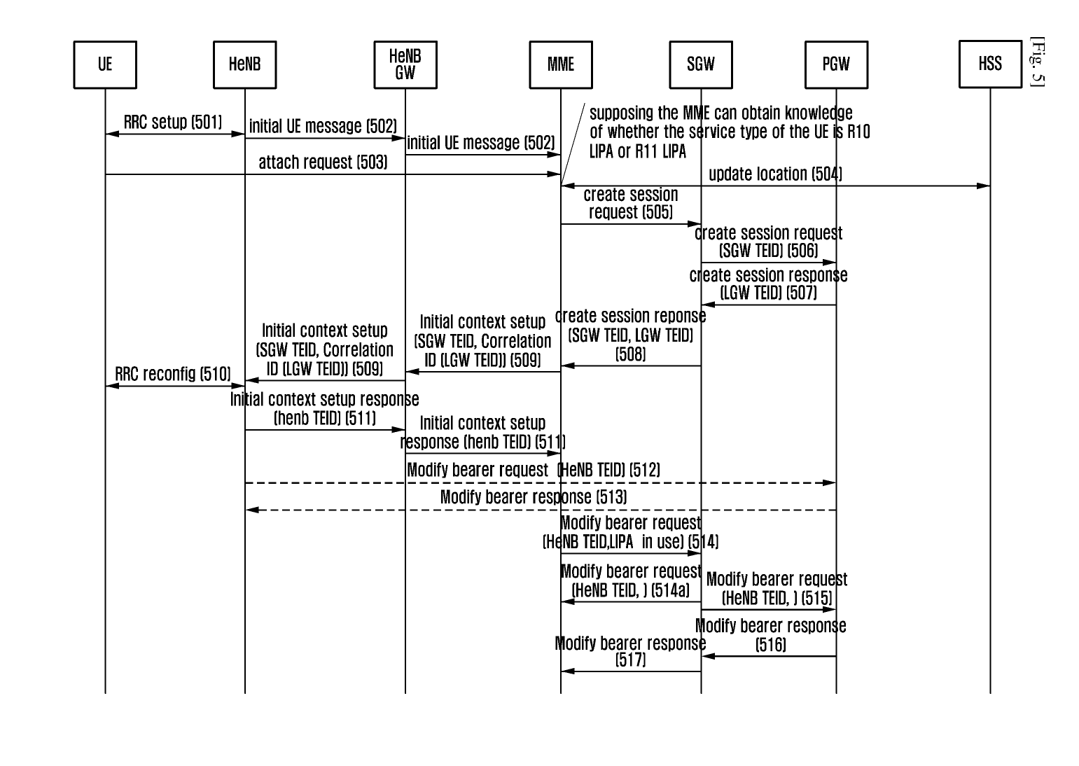

FIG. 5 is a flowchart illustrating a method in accordance with embodiment two of the present invention. As shown in FIG. 5, the method may include the following procedures.

In block 501, an RRC setup procedure is performed.

In block 502, a HeNB sends an initial UE message to a HeNB GW, and the HeNB GW forwards the initial UE message to an MME. This embodiment takes a network having HeNB GW deployed as an example. When there is no HeNB GW deployed, the HeNB may send the initial UE message directly to the MME. This procedure is identical to the procedure in block 402.

The message may include device capabilities of the HeNB. The MME may determine whether the LGW accessed by the HeNB supports the LIPA service or the SIPTO@LN service by using the device capabilities. (a) The device capabilities may be an individual identification indicating whether the current base station supports LIPA services or SIPTO@LN services. (b) Alternatively, the device capabilities may be expressed by other identifications, e.g., the IP address of the LGW accessed by the current base station. The IP address of the LGW may be used by the MME for selecting a proper LGW for a UE after the MME decides to activate a LIPA service or a SIPTO@LN service for the UE, and may also be used by the MME for determining whether the LGW accessed by the base station supports the LIPA service or the SIPTO@LN service. For example, different IP addresses may be pre-configured for indicating the LIPA service or the SIPTO@LN service. (c) Alternatively, the device capabilities may be expressed by using the IP address of the LGW and an ID of a local network name (LHN). The MME may decide whether the base station connected to the MME supports the LIPA service or the SIPTO service by using the LGW IP address and the LHN ID.

The message may include information of the IP address of the LGW for the MME to select a proper LGW for the UE after the MME decides to activate the LIPA service or SIPTO@LN service. The device capabilities are optional.

The message may include the LHN ID for the MME to select a proper LGW for the UE after the MME decides to activate the LIPA service or the SIPTO@LN service for the UE. The MME may adopt a DNS query manner where the MME may send the LHN ID to a DNS server according to the LHN ID receives, and the DNS server may return an IP address which is allowed to access the LGW.

In block 503, the UE may send an attach request to the MME.

In block 504, subscription information between the MME and an HSS is updated (update location). The MME may obtain current subscription information of the UE through the message.

The procedure of the MME making the access control decision is identical to the procedure in block 404.

Procedures in blocks 505-513 are identical to the procedures in blocks 405-413 in embodiment one.

In block 514, the MME may send to the SGW a modify bearer request which may include a new identification (LIPA in use) indicating the SGW needs to establish a single tunnel of LIPA service for the current UE. The message may also include a TEID and an IP address of the HeNB.

The procedure in block 514a is identical to the procedure in block 414.

In block 515, the SGW may send a modify bearer request to the LGW based on the MME indication information received. The modify bearer request may include a TEID and an IP address of the HeNB.

In block 516, the LGW may send a bearer modify response to the SGW.

In block 517, the SGW may send a modify bearer response to the MME.

Hence, the process of this embodiment is ended.

### Embodiment Three

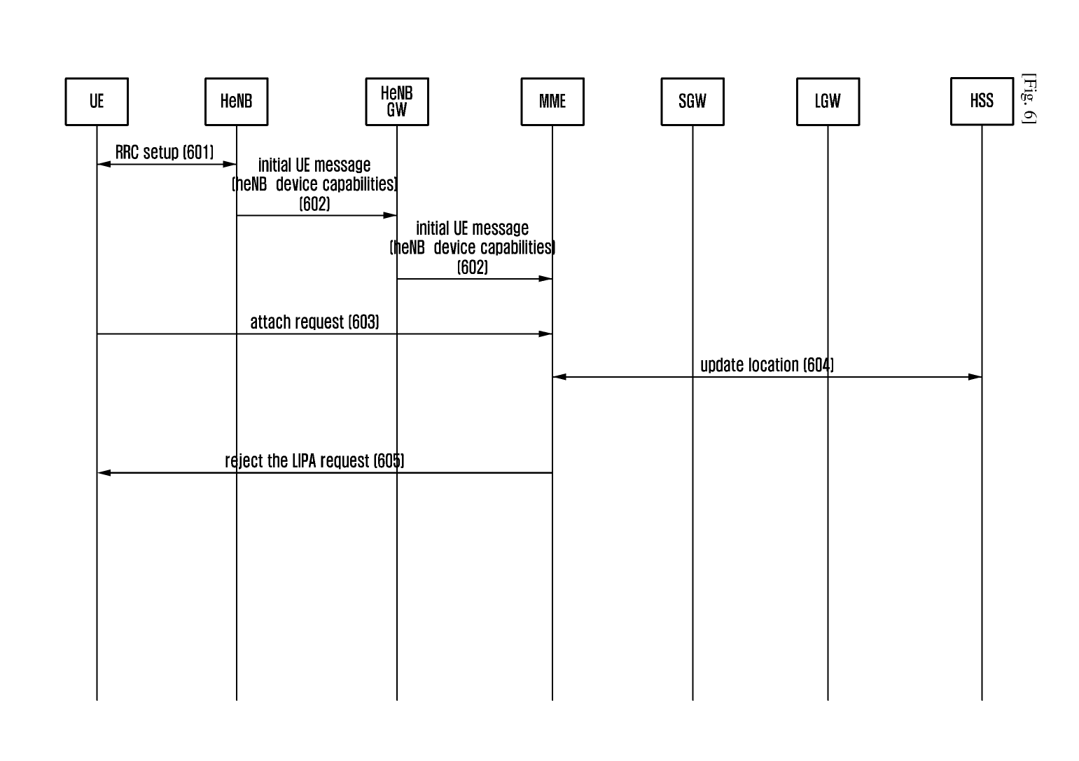

FIG. 6 is a flowchart illustrating a method according to embodiment three of the present invention. As shown in FIG. 6, the method may include the following procedures.

In block 601, an RRC setup procedure is performed.

In block 602, a HeNB may send an initial UE message to a HeNB GW, and the HeNB GW may forward the initial UE message to an MME. This embodiment takes a network having HeNB GW deployed as an example. When there is no HeNB GW deployed, the HeNB may send the initial UE message directly to the MME. This procedure is identical to the procedure in block 402.

In block 603, the UE may send an attach request to the MME.

In block 604, subscription information between the MME and a HSS is updated (update location). The MME may obtain current subscription information of the UE through the message.

The MME may judge based on the received device capabilities of the HeNB accessed by UE and the current subscription information of the UE, and perform procedures according to a result of the judgment.

Based on the access control decision of embodiments one and two, the MME performs procedures in block 605 when decides to reject the LIPA or SIPTO@LN service access request of the UE.

In block 605, the MME may send a reject LIPA request to the UE. The request message may include an identification indicating the UE may initiate an attach request or a PDN connect request immediately.

### Embodiment Four

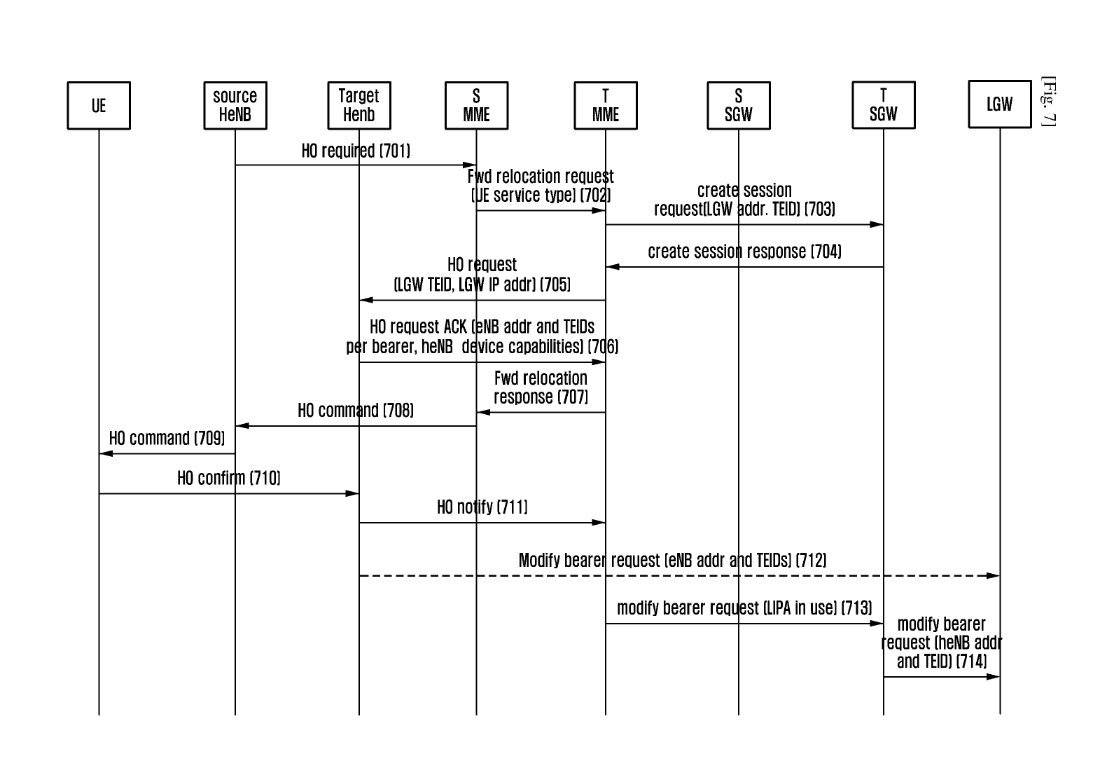

FIG. 7 is a flowchart illustrating a method in accordance with embodiment four of the present invention. As shown in FIG. 7, the method may include the following procedures.

In block 701, a serving HeNB may send a handover request (HO required) to a serving MME.

In block 702, the serving MME may send to a target MME a forward relocation request which may include an identification indicating the service type of the UE.

In block 703, in case of an SGW re-selection, the target MME may send to a target SGW a create session request which may include a TEID and an IP address of the LGW.

In block 704, the target SGW may return a create session response to the target MME.

In block 705, the target MME may send to a target HeNB a handover request (HO request) which may include the TEID and the IP address of the LGW, so that the target HeNB may establish a user plane tunnel with the LGW.

In block 706, the target HeNB may return to the target MME a handover request confirmation which may include a TEID and an IP address of the HeNB and an identification indicating device capabilities of the HeNB. The identification has been explained in block 402.

The manner of the MME making an access control decision is identical to the procedure in block 404. The MME allows the handover and performs subsequent procedures in response to a determination that the service type accessed by the UE is consistent with the device capabilities of the HeNB.

The MME may reject the HO in response to a determination that the service type accessed by the UE is inconsistent with the device capabilities of the HeNB
If the service currently to be handed over has a single bearer, the target MME may determine the handover is failed, deactivate the bearer supporting the LIPA service, and the current process is completed.
If the UE has multiple bearers, the target MME may directly de-activate the bearers supporting the LIPA service, resume the current handover process, and send no information of the bearers related with LIPA in subsequent procedures.

In block 707, the target MME may send a forward relocation response to the serving MME.

In block 708, the serving MME may send a handover complete command (HO command) to the serving HeNB.

In block 709, the serving HeNB may send a HO command to the UE.

In block 710, the UE may send a handover confirmation (HO confirm) to the target HeNB.

In block 711, the target HeNB may send a handover notification (HO notify) to the target MME.

In block 712, if the target HeNB is a device supporting R11 LIPA, the target HeNB may send to the LGW a modify bearer request which may include a TEID and address information of the HeNB.

In block 713, the target MME may send a modify bearer request to the target SGW. When the subscribed service type of the UE is R11 LIPA and the device capabilities type of the HeNB is R10 LIPA, the target MME may decide to complete the handover for the UE, and loads a new identification into the message indicating the target SGW needs to establish a single tunnel supporting LIPA.

In block 714, the target SGW may send to the LGW a modify bearer request which may include a TEID and an IP address of the HeNB to guarantee successful setup of the single tunnel.

### Embodiment 7

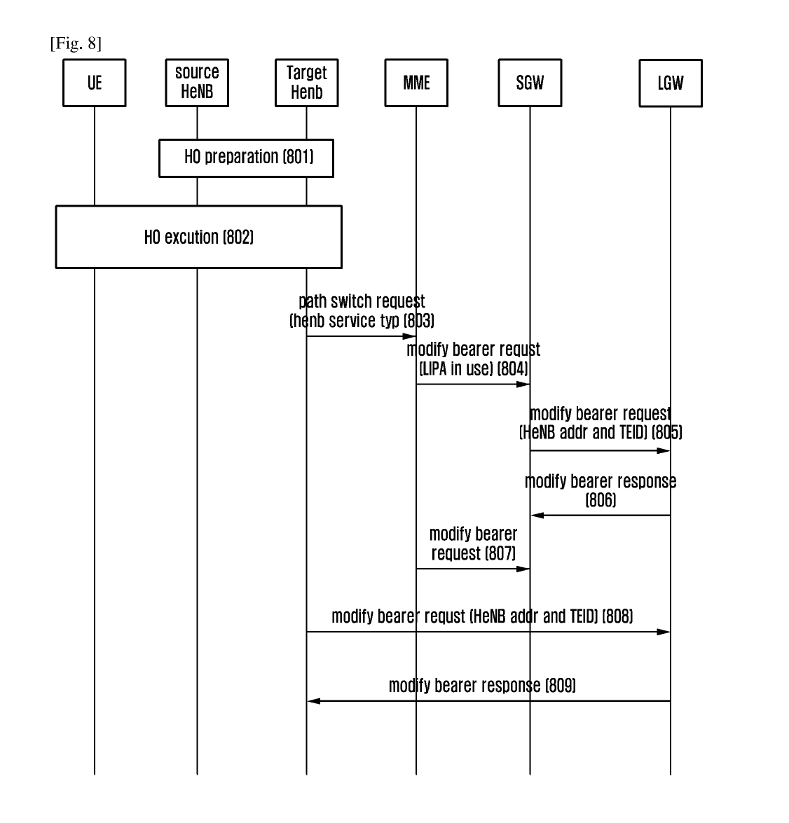

FIG. 8 is a flowchart illustrating a method in accordance with embodiment seven of the present invention. As shown in FIG. 8, the method may include the following procedures.

In block 801, a handover preparation (HO preparation) process is performed.

In block 802, a handover execution (HO execution) process is performed.

In block 803, a target HeNB may send to an MME a path switch request which may include information specifying a device type of the current HeNB. The information of the device type has been explained in block 402.

The MME may make a decision based on the device type information of the HeNB and stored subscription information of the UE.

In response to a determination that the service currently to be handed over is consistent with the device capabilities of the target base station, the MME may resume the HO. Procedures in blocks 803, 807-809 is a handover process supporting a first structure, while procedures in blocks 803-806 is a handover process supporting a second structure.

In block 804, the MME may send to the SGW a modify bearer request which may include an identification indicating an ID of a LIPA single tunnel established by the SGW.

In block 805, the SGW may send a modify bearer request to the LGW according to the received single tunnel ID. The modify bearer request may include the address and a TEID of the HeNB.

In block 806, the LGW may send a modify bearer response to the SGW.

In block 807, the MME may send a modify bearer request to the SGW.

In block 808, if the target HeNB is a device supporting R11 LIPA, the target HeNB may send to the LGW a modify bearer request which may include a TEID and the address of the HeNB.

In block 809, the LGW may send to the HeNB a modify bearer response which may include a TEID and an IP address of the LGW.

### Embodiment Eight

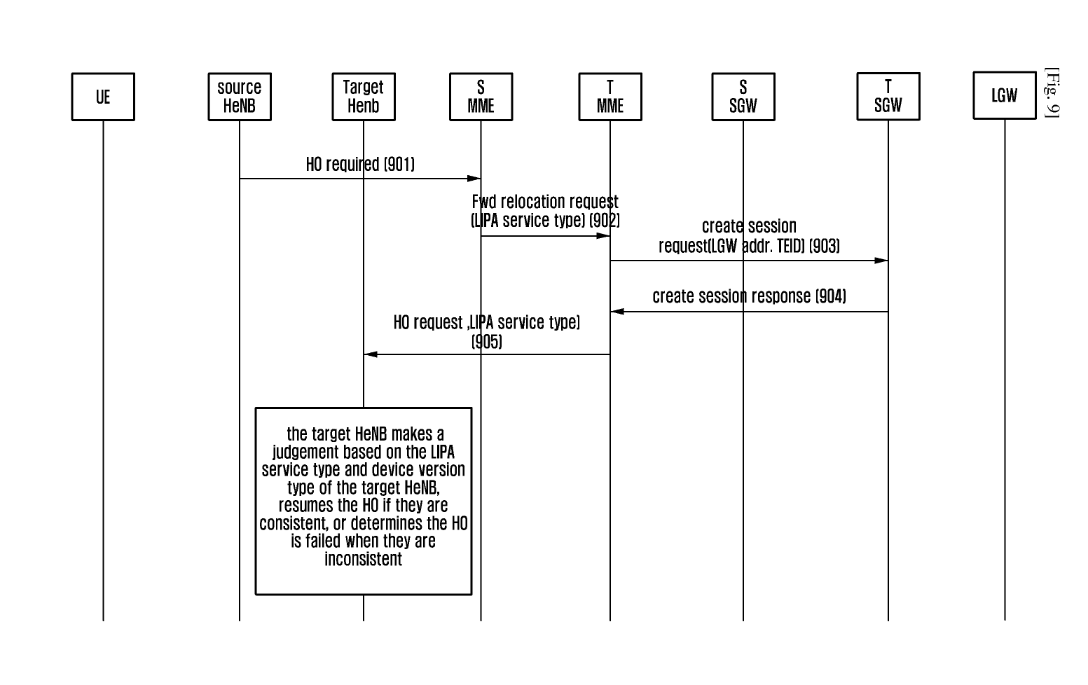

FIG. 9 is a flowchart illustrating a method according to embodiment eleven of the present invention. As shown in FIG. 9, the method may include the following procedures.

In block 901, a serving HeNB may send a handover request to a serving MME.

In block 902, the serving MME may send to a target MME a forward relocation request which may include an identification indicating the type of the service currently accessed by the UE.

In block 903, in case of an SGW re-selection, the target MME may send to a target SGW a create session request which may include a TEID and an IP address of the LGW.

In block 904, the target SGW may return a create session response to the target MME.

In block 905, the target MME may send to a target HeNB a handover request (HO request) which may include the TEID and the IP address of the LGW, so that the target HeNB may establish a user plane tunnel with the LGW. The message may include a type of a service accessed by the UE, i.e., the currently activated service is LIPA or SIPTO@ LN.

The HeNB performs the following access control judgment based on device capabilities of the HeNB and the LIPA service type subscribed by the UE.

In response to a determination that the service type currently activated is consistent with the service capabilities of the LGW supported by the current HeNB, the HeNB resumes the handover process. In response to a determination that the service type currently activated is inconsistent with the service capabilities of the LGW supported by the current HeNB, the HeNB may determine the handover is failed. Alternatively, in response to a determination that the UE accesses multiple bearers, the HeNB may determine the LIPA bearer needs to be released. After receiving a response from the HeNB, the MME may trigger a de-activating procedure for the LIPA bearer or the SIPTO@LN bearer.

### Embodiment Nine

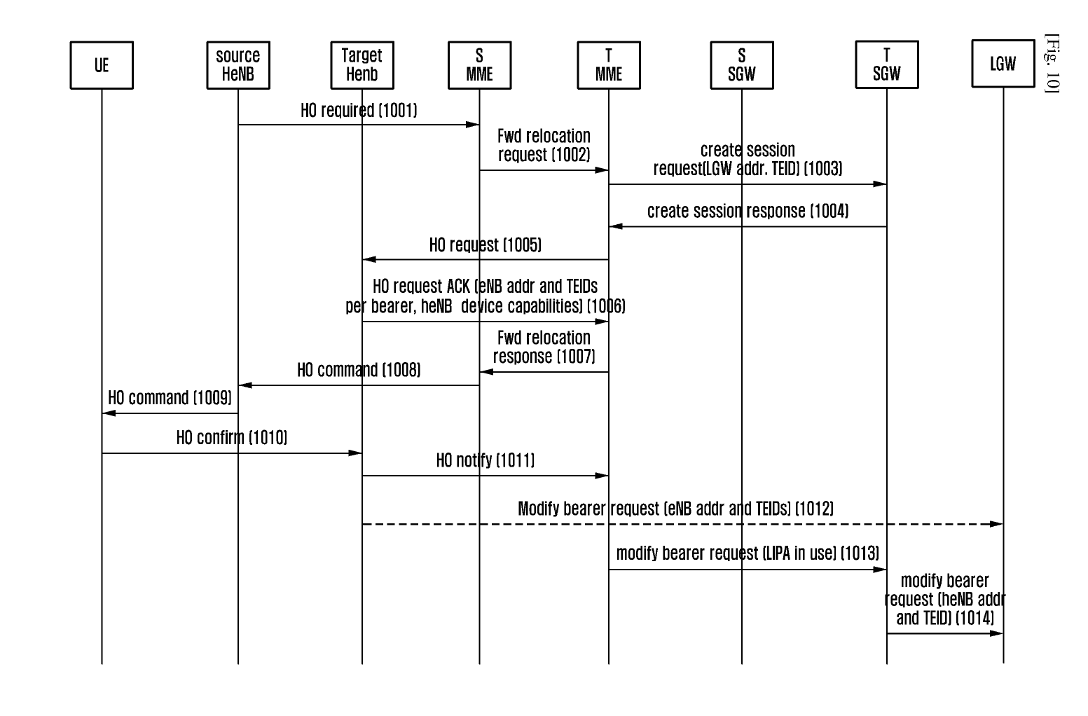

As is shown in FIG. 10, the following procedures may be performed.

In block 1001, a serving HeNB may send a handover request (HO required) to a serving MME.

In block 1002, the serving MME may sends forward relocation response (Fwd relocation request) to a target MME.

In block 1003, in case of an SGW re-selection, the target MME may send to a target SGW a create session request which may include a TEID and an IP address of the LGW.

In block 1004, the target SGW may return a create session response to the target MME.

In block 1005, the target MME may send to a target HeNB a handover request (HO request) which may include the TEID and the IP address of the LGW, so that the target HeNB may establish a user plane tunnel with the LGW.

In block 1006, the target HeNB may return to the target MME a handover request confirmation which may include a TEID and an IP address of the HeNB and an identification indicating device capabilities of the HeNB. The identification has been explained in block 402.

In block 1007, the target MME may send a forward relocation response (Fwd relocation request) to the serving MME. The message may include device capabilities of the target HeNB.

The serving MME may make an access control decision based on the received device capabilities of the target HeNB and the information of the service currently activated, e.g., supporting LIPA or SIPTO@LN service.

The manner of the MME making access control decision is identical to the procedure in block 404. The MME allows the handover and performs subsequent procedures in response to a determination that the service type accessed by the UE is consistent with the device capabilities of the HeNB.

The MME may reject the HO in response to a determination that the service type accessed by the UE is inconsistent with the device capabilities of the HeNB
In response to a determination that the service currently to be handed over has a single bearer, the target MME may determine the handover is failed, de-activate the bearer supporting the LIPA service, and the current process is completed.

In response to a determination that the UE has multiple bearers, the target MME may directly de-activate the bearers supporting LIPA service, resume the current handover process, and send no information of the bearers related with LIPA in subsequent procedures.

In block 1008, the serving MME may send a handover complete command (HO command) to the serving HeNB.

In block 1009, the serving HeNB may send a HO command to the UE.

In block 1010, the UE may send a handover confirmation (HO confirm) to the target HeNB.

In block 1011, the target HeNB may send a handover notification (HO notify) to the target MME.

In block 1012, if the target HeNB is a device supporting R11 LIPA, the target HeNB may send to the LGW a modify bearer request which may include a TEID and address information of the HeNB.

In block 1013, the target MME may sends a modify bearer request to the target SGW. When the subscribed service type of the UE is R11 LIPA and the device capabilities type of the HeNB is R10 LIPA, the target MME may decide to complete the handover for the UE, and load a new identification into the message indicating the target SGW to establish a single tunnel supporting LIPA.

In block 1014, the target SGW may send to the LGW a modify bearer request which may include a TEID and an IP address of the HeNB to guarantee successful setup of the single tunnel.

### Embodiment Twelve

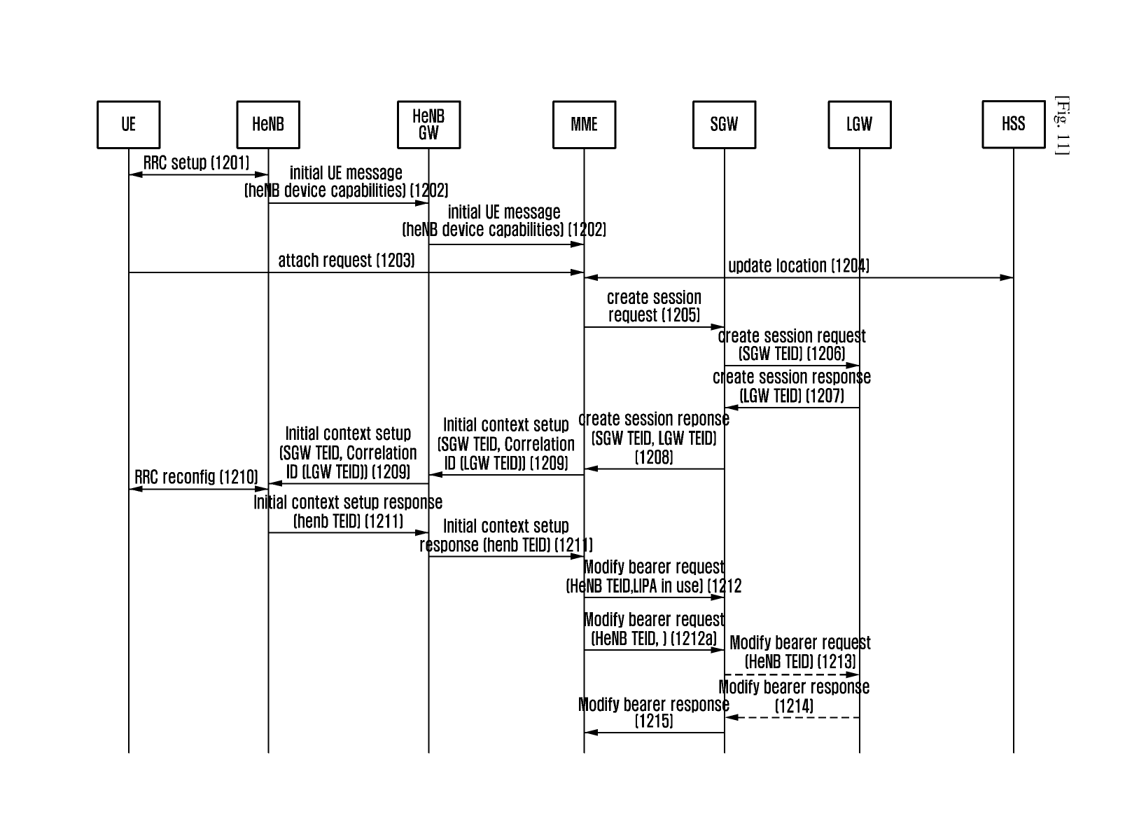

This embodiment is based on the attach process of a UE to a network in accordance with a possible structure two. FIG. 11 is a flowchart illustrating a method according to embodiment twelve of the present invention. As shown in FIG. 11, the method may include the following procedures.

In block 1201, an RRC setup procedure is performed.

In block 1202, a HeNB may send an initial UE message to a HeNB GW, and the HeNB GW may forward the initial UE message to an MME. This embodiment takes a network having HeNB GW deployed as an example. When there is no HeNB GW deployed, the HeNB may send the initial UE message directly to the MME.

Procedure in this block is the same with the procedure in block 402.

In block 603, the UE may send an attach request to an MME.

In block 1204, subscription information between the MME and a HSS is updated (update location). The MME may obtain current subscription information of the UE through the message. The procedure of the MME making the access control decision is identical to the procedure in block 404.

Procedures in blocks 1205-1211 are identical to the procedures in blocks 405-411 in embodiment one.

In block 1212a, the MME may send to the SGW a modify bearer request which may include a TEID and an address of the HeNB and a bearer ID.

1212: If the MME knows the UE performs the access via an R11 HeNB, the MME may send to the SGW a modify bearer request which may include a TEID and an address of the HeNB, a bearer ID, and information of an identification of a LIPA single tunnel established.

In block 1213, the SGW may send a modify bearer request to the LGW according to the received single tunnel ID of the LIPA service. The modify bearer request may include the IP address and a TEID of the HeNB.

In block 1214, the LGW may send a bearer modify response to the SGW.

In block 1215, the SGW may send a bearer modify response to the MME.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

1. A method for correctly establishing a local IP access (LIPA) service or a SIPTO@LN service, comprising:
receiving a service access request for a LIPA service or a SIPTO@LN service;
obtaining subscription information of a UE and device capabilities type of a base station, judging whether it is allowed to establish a LIPA service or a SIPTO@LN service for the UE; and
activating the LIPA service or the SIPTO@LN service for the UE in response to a determination that it is allowed to establish a LIPA service or a SIPTO@LN service for the UE; or rejecting the activating of the LIPA service or the SIPTO@LN service for the UE in response to a determination that it is not allowed to establish a LIPA service or a SIPTO@LN service for the UE.

2. The method of claim 1, wherein obtaining device capabilities of the base station comprises: receiving, by a mobility management entity (MME) from the base station, device capabilities indicating the base station has the ability to access the LIPA service or the SIPTO@LN service.

3. The method of claim 1, wherein after receiving an access request for a LIPA service, an MME judges whether the UE is allowed to access the LIPA service based on at least one of the following:
whether the current base station has the ability of accessing the LIPA service;
whether the UE is a CSG user; and
whether the UE is allowed to access the LIPA service according to the subscription information of the UE.

4. The method of claim 1, wherein after receiving an access request for a SIPTO@LN service, an MME judges whether the UE is allowed to access the SIPTO@LN service based on at least one of the following:
whether the current base station has the ability of accessing the SIPTO@LN service;
whether the UE is allowed to access the SIPTO@LN service according to the subscription information of the UE.

5. A method for correctly establishing a local IP access (LIPA) service or a SIPTO@LN service, comprising:
a service being handed over is a LIPA service or a SIPTO@LN service;
obtaining subscription information of a UE and device capabilities type of a base station, judging whether a currently activated LIPA service or a currently activated SIPTO@ LN service is allowed to be handed over; and
implementing handover of the LIPA service or the SIPTO@LN service in response to a determination that a currently activated LIPA service or a currently activated SIPTO@ LN service is allowed to be handed over; or rejecting the handover of the LIPA service or the SIPTO@LN service in response to a determination that a currently activated LIPA service or a currently activated SIPTO@LN service is not allowed to be handed over.
